(19) United States
(12) Patent Application Publication
(10) Pub. No.: US 2009/0152368 A1
(43) Pub. Date: Jun. 18, 2009

(54) METHOD FOR PRODUCING A TRACK SUPERSTRUCTURE WHICH UNDERWENT PARTIAL FOAMING

(75) Inventor: Tim Frenzel, Brunkensen (DE)

Correspondence Address: SHUMAKER & SIEFFERT, P. A., 1625 RADIO DRIVE, SUITE 300, WOODBURY, MN, 55125, US

(73) Assignee: MSB-MANAGEMENT GMBH, Freden/Leinen (DE)

(21) Appl. No.: 12/278,676

(22) PCT Filed: Feb. 12, 2007
(86) PCT No.: PCT/EP2007/051341

§ 371 Date: Nov. 24, 2008

(30) Foreign Application Priority Data
Feb. 10, 2006 (DE) 10 2006 006 118.7

(51) Int. Cl. E01B 1/00; E01B 27/04; E01B 27/12; F27B 7/00

(52) U.S. Cl. 238/2; 171/16; 104/10; 432/1; 432/13; 432/103

(57) ABSTRACT

The invention relates to a method for introducing a flowable and foamable reaction mixture from the top into a ballast body having sleepers embedded therein, in which method said mixture is introduced into the ballast body laterally of the sleepers, notably preferably depending on the height of the ballast body at the point of application, and in a quantity that is all the larger the more upwards in the ballast body the application point is situated, wherein the mixture is adjusted in such a way that the foam formation process will begin only when the front of the mixture flowing downwards inside the ballast body has reached the bottom side or the region in the vicinity thereof of the ballast body so that the foam formation is carried out within the ballast body from the bottom towards the top.

The invention relates to the production of a partly foamed railroad track bed structure by introducing a flowable and foamable reaction mixture into parts of the ballast body of the railroad track bed structure.

Among the traditional and most frequently used track systems today are ballasted tracks, optionally equipped with wooden, concrete or steel sleepers. This track structure has been optimized continuously from the beginnings of railroad traffic by practical use and theoretic recalculation.

To obtain an economically feasible track system, the durability of the main components—rails, sleepers, ballast and the subbase—have to be properly matched. Low life cycle costs will be incurred if the subbase has a longer useful life than the ballast bed and the ballast bed has to be renewed only when the sleepers have reached the end of their useful life. During the last decades, the strong increase in load by more trains, higher loads per axle and velocities, as well as heavy rolling stock have had the result that, for economic reasons, the track unit was reinforced first by using more rigid rail profiles and concrete sleepers. In a second phase, the subbase was improved where necessary by applying level protection layers and drainages in the course of a renewal of the track bed structure. Thus, the ballast bed factually became the weakest main element of the railroad track. The improvement of the ballast properties is an important measure for securing a sufficient useful life of the ballast bed made of stub stones which has a high pore volume in a clean state.

Presently, speeds up to more than 300 km/h are achieved (e.g. TGV) and heavy loads are transported on these tracks. The structure engineering has adapted to these structures and today has reached a high level worldwide.

From a theoretical point of view, the structure of a ballasted track is a complicated and complex task to realize. It is complicated because the ballast mass that is not a rigid, firm structure changes when dynamically influenced.

This means: When a track is laid, so-called tamping machines are used to compact the ballast after the track unit has been laid on a ballast bed of at least 30 cm in thickness. The track unit then rests on the ballast bed and transfers the loads from the passage of a train to the sleepers via the rails and from the sleepers on to the ballast bed. Ideally, the loads are then distributed in the ballast bed from stone to stone down the subjacent level and are then transferred into the subbase.

Here, the purely static transfer of the loads introduced is realized without any problems.

However, changes in the structure of the ballast bed will be caused by the dynamic load occurring during a train's passage.

As it is known, when a train passes, positive and negative loads are introduced. This means that perpendicular loads and, additionally, relieving leading and hunting waves are applied to the track. In combination with the dynamic frequency of the train's running the “stone-on-stone structure” may thus change. The ballast stones turn, becoming round in the end, and the position of the track changes. If this were an entirely uniform process, no disadvantage would result therefrom for the track system. However, this is not the case due to the routing of the track—bends, straight parts, bridges, different substrates, etc. In intervals, the ballast has to be compacted again with tamping machines, so as to preserve a good track position for a longer period.

Today, freight trains run with a load of 22.5 t per axle. This load is transferred from the bottom of the sleepers to an average of about 330 ballast stone tips, from where it is passed downward from stone to stone. Thus, only 12% of the base area of the sleeper are used as the footprint. These values hold for both horizontal and vertical load transfer. The void volume in the ballast body is about 40%, i.e. there is ample space to allow for a turning or displacement of individual ballast stones upon dynamic load.

In the past, different methods have been developed to counteract this problem:
1. Track systems without ballast, so-called “fixed railways”, have been and are developed. These may have a subbase of concrete or of asphalt.
2. After the track has been finally compacted, the ballast body is cast with a cement-like mixture, thus becoming rigid.
3. After the track has been finally compacted, the ballast body is treated with a liquid plastic material, whereby the stones are adhered pointwise at the contact points between the stones.

A variety of past approaches are known that attempt to alter the characteristics of technical structures, for example to enhance stability by effective “cohesion” of the stones.

From DD 86 201 and DE 24 48 978 A1, for example, a full or partial bonding of all ballast stones of the ballasts structure is known. This causes draining problems, since surface water can no longer penetrate the ballast body in the vertical or the horizontal direction, which is particularly disadvantageous with railways including two or more tracks and especially in bend areas. A full bonding of all ballast stones is also known from DE 20 63 727, using a bonding material, possibly adapted to be foamed. A machine with which this full bonding can be achieved is described in U.S. Pat. No. 3,942,448 and DE-U-7319950, respectively.

From DE-A-23 05 536, a method for lifting tracks is known, wherein a swelling material is introduced into the track body through the rails for the purpose of lifting the track body.

Finally, it is known from EP-A-1 619 305 to provide drain mats under a ballast bed which has been foamed only in the load transfer regions of the ballast body. The advantage of this construction of the track bed structure becomes evident particularly in railroad lines with two or more tracks. Surface water (e.g. rain water) accumulating in the surface-near region of the ballast body between the sleepers and above the partial foaming, will enter the region between two tracks and, since this region is free of foaming, will be able to flow off from there to the subgrade, whereupon, from the subgrade, the water will flow off via the drain mat of the adjacent track arranged below the ballast body of the adjacent track and on the subgrade of this track.

It is an object of the invention to provide a method for introducing a flowable and foamable reaction mixture from the top into a ballast body having sleepers embedded therein, in which method the foaming of the ballast body within the load transfer regions of the sleepers, as shown e.g. in EP-A-1 619 305, shall be reliably effected.

According to the invention, to achieve the above object, there is proposed a method for introducing a flowable and foamable reaction mixture from the top into a ballast body having sleepers embedded therein, in which method said mixture is introduced into the ballast body laterally of the sleepers, notably depending on the height of the ballast body at the point of application, and preferably in a quantity that is all the larger the more upwards in the ballast body the application point is situated, wherein the mixture is adjusted in such a way that the foam formation process will begin only when the front of the mixture flowing downwards inside the ballast body has reached the bottom side or the region in the vicinity thereof of the ballast body so that the foam formation is carried out within the ballast body from the bottom towards the top.

Thus, in the invention, it is proposed to adjust the flowable and foamable reaction mixture to the effect that the foam formation process will occur only upon lapse of a certain time after introduction of the mixture into the ballast bed. Such delays of the foam formation process are possible by selection of suitable components and additives for the flowable and foamable reaction mixture. Thereby, according to the invention, a foam formation process occurs within the ballast body from the bottom towards the top, i.e. up to a location under the sleepers. Since the process of introducing the flowable and foamable reaction mixture is performed laterally of the sleepers, it can also be accomplished that the foam formation process will occur only in parts of the ballast body, notably within the load transfer regions, starting from the sleepers and proceeding downwards at an angle of about 60°.

By way of alternative, it is also possible to first remove the ballast between the sleepers and outside the load transfer regions of the ballast body and then to introduce the flowable and foamable reaction mixture while performing the above described control of the time of foam formation process. Subsequently, ballast will be introduced again into the previously cleared regions, which will serve for UV protection of the surface-near region of the foam.

Suitably, for conditioning the ballast bed, particularly in preparation of the performance of the method of the invention, hot air is introduced from above into the ballast body, which air will laterally emerge from the ballast body, while the relative humidity of the emerging air is detected and the process of heating the ballast body will be terminated when the average humidity of the air is below a presettable threshold value.

By the drainage of humidity from the ballast bed, improved conditions are generated for the subsequent foam formation process. The introduction of heat into the ballast body can be controlled in dependence on the emerging humidity of the air in that, for this purpose, the humidity of the air laterally exiting from the ballast body is detected at a plurality of sites and an average value is obtained from these individual air-humidity values, while the heating the ballast body will be terminated when the average humidity of the air is below a presettable threshold value.

By the inventive method for introducing a flowable and foamable reaction mixture from the top into a ballast body having sleepers embedded therein, there can be realized a method for making a track bed structure for a railway on a subgrade inclined transverse to the length thereof, wherein
an elastic drain mat can be arranged on the subgrade,
a ballast body of individual ballast stones having voids between them can be formed on the drain mat,
the track (sleepers with rails) can be embedded in the ballast body, and
according to the invention, for positional fixation of the ballast stones arranged substantially only within load transfer regions of the ballast body below the sleepers, a foamable material is introduced into the voids between the ballast stones.

It is advantageous for the chemical reaction during the foam formation if the ballast body is heated or is at an elevated temperature before introducing the foamable material, which, depending on the ambient conditions, may be achieved even without heating by an additional heat source.

Further, as already stated above, sleepers with a footing of an elastic material, especially plastic material, are embedded in the ballast body.

Suitably, the per se known steps of compacting and/or causing a first settlement by vibrating the ballast body are performed prior to the step of partly foaming the ballast body, in which the same is filled with foam exclusively in the load transfer regions.

The main problem of the known ballasted track—the turning of the stones under dynamic load—is thus prevented, according to the invention, in that, after the new or renewed track has been finished, the track is foamed with a foam material in the ballast body only in the load transfer regions.

This means that all voids between the ballast stones beneath the sleeper and in the adjacent load transfer regions are closed by the foam to be introduced into the ballast body; the voids between the sleepers and outside the load transfer regions remain free, thus serving to discharge surface water. The foam is adjusted such that it will be flexible. The introduction of the foam and the forming thereof in the ballast body does not alter the morphology of the ballast body.

The foam of choice is a PU foam. PU foams have been known for decades in industry and construction. Their adaptation to the respective application poses no problems. Their use in humid weather is not detrimental but rather beneficial.

All ballast stones of the track within the load transfer regions are bonded by the introduced foam to form a unitary ballast structure. The adhesion of the foam to the ballast stones and the density of the structure of the foam can be adapted to the magnitude of the maximum load introduced, with added safety coefficient.

After the foam has cured, all forces introduced by a train riding thereover can be transferred via this homogenous structure, notably through the ballast stones and not through the foam which serves to fix the ballast stones in a stable position.

Since the foam is composed of a plurality of pores, no rigid ballast body is obtained by closing the voids. Rather, a structure with an infinite number of “shock absorbers” is formed. Thereby, an acoustic insulation is obtained in addition.

The present invention thus takes an alternative approach to the stabilization of the ballast body without influencing its morphology and with consideration to the problems of draining.

This, with the invention, there can be provided a track bed structure for a railway on a subgrade inclined transverse to the length thereof, which track bed structure is provided with
a ballast body of individual ballast stones, and
sleepers embedded in the ballast body, on which rails may be mounted, the ballast body comprising load transfer regions beneath the sleepers, said regions being effective to receive loads acting vertically on the ballast body via said sleepers when a train rides on the rails, and to transfer these loads to the subgrade below the ballast body.

In this track bed structure, substantially only the voids between the ballast stones within the load transfer regions of the ballast body are filled with a foam material, especially a PU foam material, for fixing the same in a stable position, and, further, an elastic drain layer can be arranged between the ballast body and the subgrade.

The basic idea is to be seen in that the ballast body is filled only partly with a foam material, however, within the above-mentioned regions, the voids between the ballast stones are substantially completely filled with this foam material, it being guaranteed that the track system morphology remaining unaltered by the foaming as compared to the state of the ballast body before the introduction of the foam material. These regions of the ballast body are the load transfer regions beneath the sleepers, these load transfer regions extending obliquely sideward from the sleepers and below the sleepers. By this partial foaming of the ballast body, as provided by the invention, the voids between the ballast stones within the zones of the ballast body between the load transfer regions remain free so that surface water can flow away downward or, within these zones, to the sides. Surface water reaching the ballast body from the sides can also pass through the ballast body in the horizontal direction.

Due to the partial foaming of the ballast body, it is just those ballast stones that are most “loaded” during a train's passing over the track that remain in a stable position. Thus, they permanently maintain the position assumed after the compacting and the (artificial) first settlement of the track bed structure, and they do so substantially for the entire service life of the track bed structure. A subsequent compacting, as it is required today for track ballast bodies, can be omitted.

A foam useful with the present invention is a rigid foam or a semi-rigid foam, i.e. a foam that mounts considerable resistance against deformation. The foam must have a sufficient pressure resistance. The foam may be adjusted with respect to pressure resistance, reaction times, reaction components, and pot life. Useful foam materials are, among others, polyurethane (PU), polyester (PES), polystyrene (PS) or polyvinyl chloride (PVC) foams. The foam may be closed-cell or open-cell foam. Open-cell foams are advantageous in that they are acoustically effective, which is favorable in track structure applications. The foam should be elastic, of long-term stability, resistant to degradation, fire-resistant, resistant to vermin and to chemicals.

To provide a possibility for draining below the track bed structure, the ballast body is arranged on an elastic drainage layer. Here, drain mats known for drainage purposes may be used, such mats being supplied, for example, by Rehau A G. Porous rubber mats or mats of another elastomeric material are advantageous. Elastomer granulates are particularly useful, whose particles are interconnected while leaving voids extending horizontally and vertically through the mats. For example, particles of recycled tires are suited for making such elastic drain mats. An elastic elastomeric drain mat can receive high weights and contact forces, is stable over extended periods and resistant to degradation, and also has the other properties mentioned above that preferably apply to the foam.

Up to the present, drain mats could not be used under ballast bodies, since they cannot withstand the loads that occur over time and are caused by several compacting operations. According to the invention, however, only a single compacting operation is required, namely when making the track bed structure. In this respect, it is another merit of the invention to have been successful in providing a draining material under the track bed structure due to the elimination of subsequent compacting operations. The drainage causes a controlled and directed discharge of water that effectively prevents an erosion of the subgrade (ground level). Further, as described above, the material of the drain mat contributes to the long-term stability thereof, whereby it maintains its (horizontal) porosity even under high pressure loads.

For a further fixation of the ballast stones within the load transfer regions, it is feasible to provide the bottom faces of the sleepers with an elastic material, especially a plastic material (so-called sleeper footing). Such sleepers with footings are found in EP-A-1 298 252, for example. The ballast stones contacting the sleeper penetrate into the elastic material of the sleeper footing, whereby a fixation similar to a “catch connection” is obtained.

The PU foam introduced improves the track body in many ways:
The subgrade beneath the ballast is protected from frost by the high insulating capacity of the air micro-voids in the PU foam.
The subgrade beneath the ballast is protected from water.
The risk of a distortion of the track in the horizontal or vertical direction is reduced, since higher forces can be received.
The resistance of a track to transverse dislocation is increased.
The dynamic load on the subgrade and the vicinity is reduced.
The calculation methods regarding the positional stability of a track can be optimized.
The ballast body has an acoustically insulating effect (reduced transfer of vibrations from the track body both via the ground and the air, with the drainage mat additionally serving for sound decoupling).

The requirements of the present method and the ballast body, respectively, are as follows:
1. washed ballast stones
2. tracks, compacted and approved under railroad engineering aspects
3. track ballast cross section thermally prepared—temperature parameter
4. curing times and flexibility of the foam can be influenced
5. absolute full foaming of the respective load transfer zones (angle of approx. 60°) beneath the sleepers
6. recyclability according to KrW/AsfG
7. compliance with requirements as to shear resistance, tear resistance and spring stiffness of the foam depending on the respective application.

The track system of the present invention is built as follows:
1. After having finished the subgrade level and prior to applying the track laying ballast, an elastic drain mat (e.g. Securdrän®, available from Naue-Fasertechnik GmbH & Co. KG) is placed on the surface of the PSS (level protection layer) beneath the footprint of the ballast. It is thus guaranteed that in lines with two or more tracks the drainage of the center is permanently secured. In one-track lines, this can be omitted; a drainage of the edge zone that is higher due to the inclination of the level is obtained (this is also true for multi-track lines).
2. The bottom faces of the concrete or steel sleepers to be built in are preferably provided with a footing of plastic material according to prior art (e.g. EP-A-1 298 252). Thus, upon compacting, the ballast stones are wedged into the structure of the plastic material and retained there.
3. The track built and compacted using the tamping machine is treated additionally with a track stabilizer of known construction. Thereby, first settlements otherwise caused by the train load to be expected are anticipated. The track bed structure is now in a state for approval under railroad engineering regulations.
4. The track is foamed beneath the sleepers and in the adjacent regions of pressure dissipation in the ballast body. To this end, the ballast body is advantageously thermally treated and cleaned (washed ballast stones) beforehand.

The present invention is not based on the assumption that loads from train operation are transferred or dissipated by the foam. The built-in foam stabilizes the ballast body and prevents the ballast core to become displaced from the ballast body made and compacted with the tamping machine. The approved quality of the veritably stable ballasted track is maintained as built for a long time. In this respect, the durability of the foam (e.g. PU) and the composition thereof are of great importance.

As a rule, the technical behavior of particle-supported structures is not altered when foam (e.g. PU) is used. Only the properties of technical strength and rigidity are substantially enhanced. Moreover, PU foam also improves dynamic features regarding properties such as the insulating level and the velocity of the load pressure waves (e.g. compression wave, shear wave and surface wave).

When using a foam (e.g. PU), it is desirable to make sure that the reinforced and stabilized subbase functions on an acceptable level during its useful life.

PU foam is preferably used in the proper spatial position and to the proper depth to guarantee that the improvements in the technical behavior are achieved. Moreover, PU foam is preferably built up chemically to be sure that its desired properties are appropriate for the respective application with consideration to rigidity, strength, viscosity, fatigue limits, acoustic insulation, temperature range, biochemical and hydroscopic properties, curing time and service life. The market offers freely available foams that can tolerate temperatures in a range from −30° to +80° C., are resistant to vapor and water, do not shrink or exert any dwell pressure, and are resistant to excrements (this should not be neglected, since many passenger wagons still have open toilet systems and thus discharge excrements onto the ballast). To achieve the desired behavior and a predictability, additional agents can be used in the PU foam to further extend the chemical properties. There are plenty of ready-mixed foams with corresponding properties that will be selected according to the given circumstances.

The invention provides a stabilized ballast superstructure in a railroad track made according to this method. Preferably, PU foam can be used to increase the vertical and/or longitudinal stability of the subbase (e.g. the rigidity and strength). The system should be controlled carefully to guarantee that the dynamic, vibratory or static loads and forces remain within the fatigue or load limits of the superstructure reinforced with PU foam, including a predefined safety factor and with consideration to the desired life cycles. Adding a PU foam causes a positive change in the static and dynamic behavior of the superstructure made of particles, thus also changing the overall and partial behavior of the subbase.

Types of ballast superstructures that are reinforced and stabilized by the previously described treatment method may also be used for:
a rapid stabilization of overloaded subbases until their final repair of the track section (e.g. removing slick and “wet spots” in a railroad track),
vertical, lateral and longitudinal stabilization (in a track e.g. transition curves, high banks, to reduce maintenance efforts, for example),
stabilization of tunnel tracks,
reinforcement of bridge tracks, including the transitions before and behind bridges to prevent load surges,
reducing the load on the track system by increased PU foam rigidity and strength properties,
preventing induced plastic load on and attrition of the separation of particles (e.g. by splintering) by almost completely preventing the movement of the particles,
reducing the occurrence of soiled particles,
according to the invention, PU foam membrane can be employed (e.g. at contact sites between different subbase materials) to prevent the intrusion of dirt into the top ballast/railway ballast,
supporting, in combination with the drain mat to be provided, the prevention of flow erosion of the surface and the subbases,
allowing for an increase of applied loads and of the speed of vibrating loads without any significant increase in maintenance of the subbase, and reducing the damages to the subbase caused by the loads applied,
reducing the generation and transmission of ambient noise,
if desired, allowing for a low cost high-power cleaning (e.g. suction devices) of the reinforced superstructure to maintain tidiness (garbage, excrements, leafs, twigs, cigarette butts, etc.) by bonding the ballast surfaces between the sleepers with another (UV resistant) material in a single operation,
improving the static and dynamic performance parameters of the super-structure and the subbase.

The composition of the foam is selected on the basis of the stiffness and strength properties required by the composite. Specifically, the tensile strength and shear strength properties are determined as a part of the construction process.

In areas with unfavorable geological formations, the foam properties (e.g. rigidity) are designed such that it can be guaranteed that an effective cushion-like foundation of stabilized ballast is built over the weak area. If the rigidity is high enough, a more uniform load distribution is achieved at the interface with the track body.

For track switches with high maintenance expenditure, the foam properties are selected such that the strong vertical forces are distributed more effectively under the track switch, however, at the same time retaining good damping properties of the composite. A lifting of the sleeper by the introduction of the foam is substantially excluded.

When new tracks are laid, bores 20 may be provided during manufacture at different places in the sleepers 11 so that the foaming material can be directly injected into the underlying ballast, stabilizing the same completely.

To allow for a vertical/horizontal adjustability in newly laid tracks, commercially available rail fasteners (known as being mounted in “fixed tracks”, for example) have to be provided and mounted to be able to later regulate a possible settlement of the subgrade.

As is obvious from the description and the enclosed drawings, the track body comprises foamed ballast and non-foamed ballast.

The foamed region is always located under the sleeper and in the load transfer regions. This forms a cone-like foamed structure in the area of the sleeper.

Due to the e.g. two-track routing in straight line sections or in bends with the necessary track banks, the selected sparing foaming of the ballast bed forms regions in which the incidental precipitation can not be discharged in the usual manner as would be the case with a completely open ballast bed.

The selected embodiment including the plastic drain mat placed on the sub-grade level addresses this problem.

In all instances, the precipitation will reach the plastic drain mats in the problematic zones, from where it is discharged outward in a controlled manner.

Due to the chosen placement over the entire surface under the sleepers, water leaves no traces of erosion on the subgrade and thus contributes to the protection of the subbase of the track.

Further, according to the invention, it is proposed to prepare mineral fractions such as e.g. rock matter and particularly track-ballast stones, gravel etc. connected to each other by a preferably foamed polymer material such as e.g. a PU-based foam, in that
the polymer-fixed mineral fractions are introduced into a furnace, preferably a rotary furnace,
the polymer-fixed mineral fractions are heated in such a manner that the polymer material is converted into the gaseous phase,
the gas is subjected to an exhaust-gas cleanup process, and
the mineral fractions substantially freed of polymer are removed from the furnace.

The invention will now be explained in detail with reference to the drawings. In the Figures:

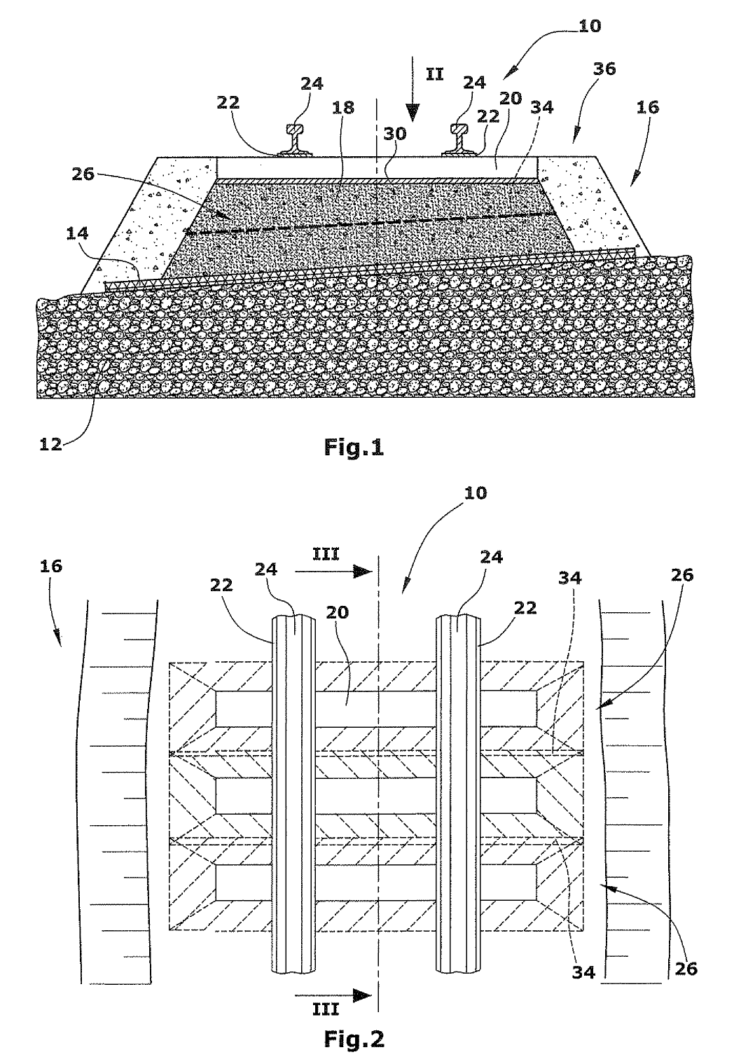

FIG. 1 is a vertical section through a track bed structure according to the present invention, intended for a one-track line section,

FIG. 2 is a top plan view on the track bed structure of FIG. 1,

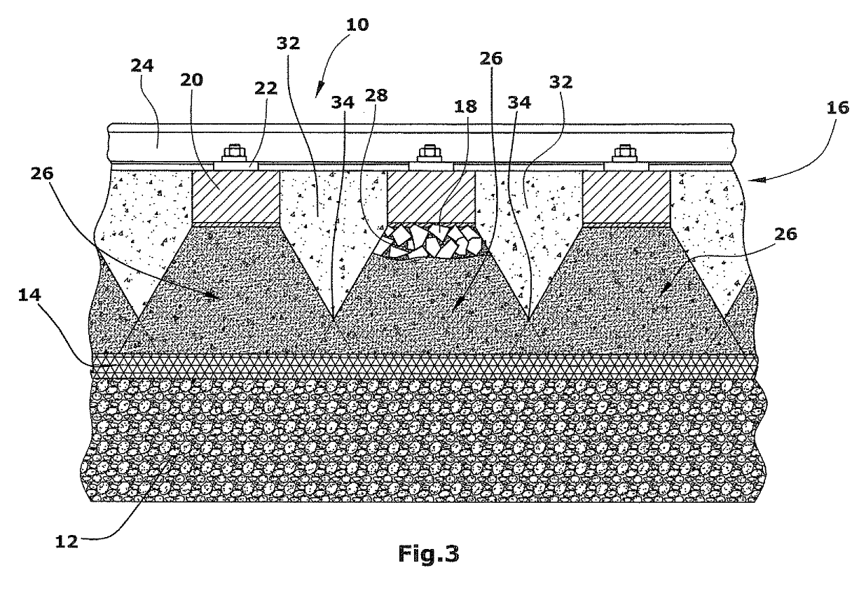

FIG. 3 is a vertical longitudinal section through a track bed structure according to the invention, intended for a one-track line section, and

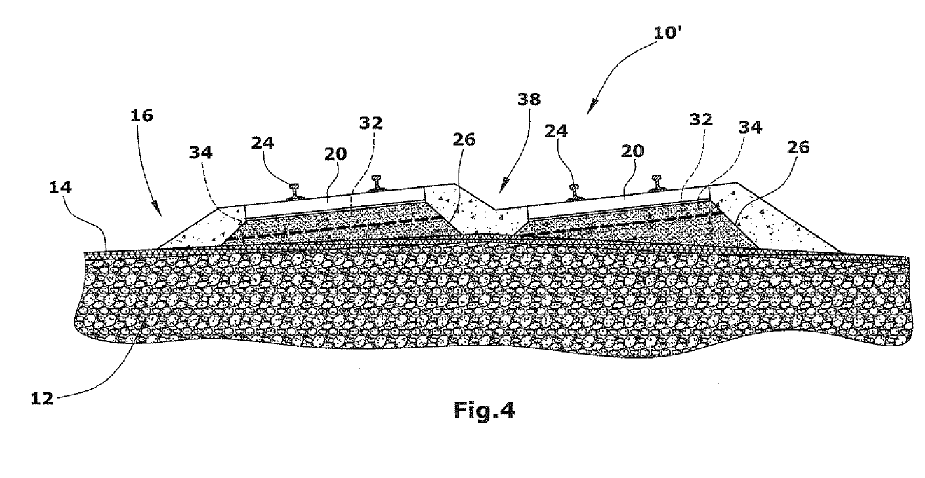

FIG. 4 is a vertical section through a track bed structure according to the invention, intended for a two-track line section.

FIGS. 1 to 3 illustrate a first embodiment of the present track bed structure. The track bed structure is situated on a subgrade or level ground 12 that is inclined as usual and may have a protective layer of asphalt or gravel. A drain mat 14 lies on the subgrade 12 (level), on which a ballast bed 16 of individual ballast stones 18 (indicated in FIGS. 1 and 2 and shown in detail in FIG. 3) is applied. Sleepers 20 (of wood, concrete or steel) are embedded in the top portion of the ballast bed 16, to which the rails 24 are mounted by means of especially vertically adjustable fastening points (schematically indicated at 22).

Starting from the sleepers 20, the load transfer regions 26 are defined in the ballast bed 16, within which the loads introduced during the passage of a train over the rails 24 are transferred to the subgrade 12.

In the section of FIG. 3, these load transfer regions 26 are of a trapezoidal shape. In the end portion of the ballast bed 16 facing the subgrade 12, the load transfer regions 26 merge. In top plan view, the load transfer region 26 is as illustrated in FIG. 2. The regions between adjacent load transfer regions 26 are substantially V-shaped.

Prior to the start-up of the track bed structure 10, the ballast bed 16 is compacted and vibrated to cause a first settlement.

According to the invention, the voids between the ballast stones 18 are now completely filled with foam within the load transfer regions 26, preferably with a PU foam 28 adjusted according to the requirements and loads. Regarding the pressure resistance, adhesion and foaming behavior, PU foams may be adapted to the respective requirements, as known per se, resulting in a foam material optimized for the respective application. The ballast stones 18 within the load transfer regions 26 are thus fixed in position; the sleepers 20 have footings 30 of (elastic) plastic material on their underside. The foam may also be provided laterally of the lower portion of the sleepers 20 so that these are embedded in ballast bed portions provided with foam 28.

As is obvious especially in FIG. 3, in the present track bed structure 10, the regions 32 of the ballast bed 16 between the load transfer regions 26 remain free of foam so that precipitation can flow off transversely through the track bed structure 10. By providing an inclination along the interface between two adjacent load transfer regions 26, indicated at 34 in FIG. 3, which forms the base of a zone 32, this drainage is further enhanced. Precipitation falling on the ballast bed 16 on the sides of the track outside the load transfer regions 26 (as indicated at 34 in FIG. 1) or precipitation accumulated at the side of the ballast bed 16 will be discharged via the drain mat 14 below the track bed structure 10.

The benefit of a drain mat 14 below the track bed structure becomes particularly obvious with line of two or more tracks, as illustrated in FIG. 4. As far as the individual elements of the track bed structure 10′ of FIG. 4 are identical or similar to the elements of the track bed structure 10 of FIGS. 1 to 3, they bear the same reference numerals in FIG. 4.

Precipitation accumulating within the zones 34 of the right part of the ballast bed 16 in FIG. 4 flows off to the center 38 of the ballast bed 16, from where it is drained via the left part of the drain mat 14 in FIG. 4 under the left track in FIG. 4.

The following device, for example, is suitable for introducing the foam into the ballast bed:

Railroad tracks are conventionally laid in ballast beds onto sleepers of different materials. Since wooden sleepers can be conserved only by use of problematic substances, use is made largely of concrete or steel sleepers. The forces resulting from the mass of the trains and from the dynamic effects of the movements of the trains are transferred from the rail via the sleeper into the ballast body. This load transfer takes place substantially in a region at an angle of 60°. In the viscous ballast region, the introduced forces cause a movement of the ballast stones which, similar to the effects acting on ballast matter on riverbanks, leads to abrasion of the edges and thus to a rounding of the ballast pieces.

To prevent these effects, the ballast body is fixed by use of foam, preferably polyurethane, in the region of the load transfer. The foam will enclose the ballast pieces in a form-locking manner and enter a permanent connection with their surface. The foam is adjusted to have flexible properties and will not alter the morphology of the ballast bed. Thus, the static structure of the ballast will remain fully intact. In the upper region of this foamed ballast body, the concrete or steel sleeper or switch construction weighing on the ballast body will be permanently bonded to foam. Thereby, the effect of the transfer of horizontal forces into the ballast bed, which in wooden sleepers is obtained by the clawing of the ballast stones into the underside of the sleepers, is considerably improved and rendered permanent.

As a further effect, apart from the fixing, there is obtained a considerable reduction of the vibrations from the track body via the ground as well as via the air.

For the drainage of precipitation water which may accumulate between the tracks and the formed foam cones, a drainage mat of structured recycled rubber is a inserted under the ballast body. The mat is configured to drain the precipitation water horizontally under the ballast body. The mat is on both of its sides surrounded by a nonwoven, preferably a geotextile, thus effecting a long-term prevention of clogging of the pore volume. To facilitate the mounting process, the longitudinal edges of the geotextile are formed with alternately projecting portions so that the abutting edge to the respective next mat is covered, i.e. that the nonwoven on its top side projects in the region of one or two edges of the mat and that the nonwoven on its bottom side projects in the region of one or two edges of the mat opposite the above edges.

For introducing the foam into the ballast bed, there is preferably used the following device:

The foam is introduced into an existing track bed which has been washed by a cleaning machine and provided with a drainage path, or into a track bed newly built according to specifications (washed ballast, drainage path) using a device mounted on a railway vehicle. This device comprises the following sections:
a traction vehicle
a supply store for each respective tank holding the components of the foam
a supply store for fuel used to heat and dry the track body
a heating and drying unit, pressurized air supply store
a foam applicator
measuring and control unit with documentation.

The traction vehicle may be a vehicle allowing for a step operation and a displacement of <1 m/sec, whereby the unit can be positioned with an accuracy in the centimeter range.

The supplies stores are equipped with KTCs that may be filled in the plant and may be positioned on and taken off the unit by use of a crane.

The heating and drying unit comprises one or a plurality of bells, which may be lowered and into which hot air from a support burner is supplied by blowers via air conduits. The bells are provided with a sealing bead toward the ballast body and toward the track regions so that, as far as possible, no hot air can escape upward from the ballast bed but only, as far as possible, laterally. Three of these units are arranged in series to set the necessary parameters of the foaming depending on the outside temperature and the humidity of the ballast. With the aid of built-in elements which are adapted to be folded out and which are fastened inside on the heat aggregates, it is also possible to conduct the heat separately to the tracks so as to heat the tracks to a specific operating temperature or to cool them. In the latter case, cooling aggregates, working via an airpath arrangement, will be activated to blow a cool airflow around the rails for cooling them. The heating may be effected using petrol products, gas or natural vegetable oils. The exhaust gas heat and the waste heat of the traction vehicle could also be used. The warm air saturated with humidity will exit, laterally of the sleeper region, from the track or ballast body, respectively. The condensation generated herein in the lateral region will cause no disturbances because it does not occur in the region of the load transmission which is the target of the foam fixation. By measuring the humidity of the exiting air, the effectiveness of the treatment of the ballast is checked and controlled.

The foam is introduced into the heated and dried ballast. To this end, a device is used, for example, that has up to eight application nozzles per sleeper side and can serve a plurality of sleepers, e.g. ten, at the same time. The foam lances may be lowered individually into the ballast bed by means of a driving means. The necessary amount of lowering is calculated for each nozzle by a process computer by determination of the inclination of the track body. Within the device, the nozzles may be displaced by lateral drives and are positioned immediately beside the sleeper body with the aid of measuring means. After the lances have been lowered to the calculated point, the foaming process controlled by the process computer is initiated and documented. In this process, by a corresponding pumping activity for each nozzle, the calculated amounts of components are pumped into the mixing head at the top end of the nozzle, where they are mixed and are subsequently pressed into the ballast body. The computer detects the end of the foaming process and turns the pumps off or closes the valves at the mixing head. The lance is at once blown free by use of pressurized air.

After this cycle, the device is raised together with the heating bells. During the phase of displacement of the device, the heating of the air and the blowers are switched off. The machine unit may then be displaced to repeat the procedure at the next segment.

The nozzles are removably mounted to a part that receives the drive, acting as a support for the vertical insertion into the ballast body. The mixing head is mounted thereon. The lower part of the nozzle is beveled so that the nozzle cannot rest in abutment on a ballast stone and thus cause a closure of the lower orifice. The tip of the nozzle will either effect a displacement of an unfavorably situated stone or create sufficient free space for guaranteeing an unobstructed discharge of the foam components.

The adjustment of the foam with regard to the starting time for the foam-formation reaction and the reaction time is performed in such a manner that a conical foam structure is formed in the ballast bed and the ballast body is thus fixed in the load-transmission cone from the bottom to the lower edge of the sleeper.

The need for lancets can be obviated in that discharge nozzles for the foamable, reactive, flowable mixture are provided or positioned above the ballast bed. The nozzles are either stationary or displaceable transversely across the track body. The reactive mixture is adjusted in such a manner that the foam formation process will start when the flowable mixture has reached the lower-most region of the ballast body. Thus, the foam formation process is performed in a an ascending manner, as it were, from the bottom towards the top. Depending on the height of the ballast bed at the position of the nozzle, the rate at which the mixture is applied onto the ballast bed is changed. (The higher the ballast bed is, the larger the discharged quantity per time unit will be.) Thus, the respective quantity of the mixture that is required due to the height of the ballast bed will be applied across the whole width of the ballast bed below the track bed. The introduction of the mixture is performed on both sides of each sleeper (i.e. when viewed in the direction of the tracks, in front of and behind the sleeper directly to the side thereof), preferably simultaneously. Thus mixture, due to its viscosity, will from both sides of the sleeper also proceed in the region under the sleeper by conically spreading downward within the ballast body. Then, consequently, by the foam-formation process starting from below, reactive mixture will proceed from below up the region underneath the sleeper, because the advancing foam front will press still non-reacting quantities of the mixture from below towards the sleepers.

The nozzles for the introduction of foam are mounted to the machine rack at a site corresponding to the insertion position. Using hydraulic or electric step actuators, this rack can be displaced both in a rectangular direction, i.e. transversely to the track, and upwards and downwards. In this manner, it is guaranteed that all computed insertion positions for the reactive mixture can be serviced according to the prescribed process.

A precondition for the above described system for a ballast bed to be arranged below tracks, switches and junctions resides in a track body including ballast, sleepers and tracks, which has been produced in the usual manner and has been approved of, with the following exceptions:
Use should be made exclusively of washed ballast without dust portions
Between the ballast and the subbase, a drainage mat is to be inserted. The mats should preferably be laid without defective sites so that the drainage of wastewater from the intermediate space can occur fully laterally.

After approval of the track body, the ballast between the sleepers and outside the load transfer regions is removed (and e.g. deposited to the side). After foam formation, subsequent to a waiting period of e.g. 24 h, the ballast will be repositioned.

The introduction of the foam is performed by a system performing the following operational steps:
Providing optimized conditions for foam formation by drying and heating the installed ballast, the duty cycle of the heating being controlled in dependence on the ballast height, i.e. the ballast volume. The conditioning is performed by blowing hot air into the ballast.
Introducing the foamable flowable reaction mixture, controlled in dependence on the height of the ballast that is computed by the process computer on the basis of the measured track inclination, so that the load transfer cone below the sleeps will be foamed and thus fixed.
The dosed quantities are computed, controlled, logged, and documented for each application point so that, with the framework of automatic quality assurance, defective sites can be immediately detected and thus be excluded or touched up.
The foam is produced by automatic dosing and mixing plants, thus allowing to safeguard a constant quality. In the lines from the tank to the mixer, the components are thermostatted.

### Environmental Acceptability

The above introduction method has no consequences of relevance for the environment. The components for the foam are transported in tested and approved containers (GGVS/GGVE/IMO); storage at the construction sites will not take place; and transportation is performed according to the just-in-time principle.

The processing system is controlled in such a manner that both components can only be conveyed at the same time and can be discharged from the system in a mixed condition. Thus, there can be discharged only foam which is not classified as a hazardous material and cannot have toxic effects. The polymerization reaction will be concluded already after about 20 seconds. During this period, the system is not accessible.

The foam contains only a very small part of catalysts which are ranked among the amines and can be washed off with rainwater. These are substances which are biologically degradable in a very easy manner and have an extremely short biological half-life. The results of the elution tests are attached hereto per enclosure. The tests revealed a significant decline of the eluate value in the TOC already after a brief exposure period, which coincides with the expectations. Subsequent to polymerization, which occurs already after about 20 seconds, the rest of the substances of the foam are fully water-insoluble. A dissolution of parts of the foam, also in other solvents, will not be possible so that, after the elution of the catalyst amines has faded, there is reached an absolute environmental compatibility under observation of the mounting specifications.

In case of fire, it may be assumed that polyurethanes are self-extinguishing, which to the same extent holds true also for the rubber sheet used as a drainage mat which as a building material can be classified among B2. The gases generated during the burning process and the substances which may be discharged as part of the fire-fighting water can largely be considered as non-toxic. Of course, one might imagine scenarios wherein, caused by incomplete burning in case of under-stoichiometric supply of oxygen, toxic gases such as e.g. carbon monoxide could be generated in large quantities. This, however, would have to be attributed not to the substances used but to a topographic situation which already in itself could lead to negative consequences up to lethal effects.

In railroad routes leading through tunnels, to reduce the potentially inflammable material in any case, the products are enriched by a highly nitrogenous substance, rendering them practically non-inflammable. As to further tests, reference is made to the attached literature.

### Dismantling—Recycling

In case of dismantling of a railway line, irrespective of the reason of the dismantling, the foamed body can be removed and, by application of a method specially designed for the purpose, be processed into clean ballast. In the process, the thermal decomposition of the polyurethane occurs at temperatures <550° C. so that the ballast stones will remain unaffected in their morphology, i.e. can be reused without any further treatment.

The drainage sheets will be taken up and supplied to a material recycling process. This will lead to an identical product again.

1. A method for introducing a flowable and foamable reaction mixture from the top into a ballast body having sleepers embedded therein, in which method
said mixture is introduced into the ballast body laterally of the sleepers, wherein the mixture is adjusted in such a way that the foam formation process begins only when the front of the mixture flowing downwards inside the ballast body has reached the bottom side or the region in the vicinity thereof of the ballast body so that the foam formation is carried out within the ballast body from the bottom towards the top.

2. The method according to claim 1, characterized in that, prior to the introduction of the mixture, the ballast is first removed between the sleepers and outside the load transfer regions of the ballast body and, after foam formation, is applied again onto the ballast body between the sleepers for UV protection of the surface-near region of the foam.

3. A method for conditioning a ballast bed wherein, in said conditioning method
hot air is introduced from above into a ballast body, which air will laterally emerge from the ballast body, while the relative humidity of the emerging air is detected and the process of heating the ballast body will be terminated when the average humidity of the air is below a presettable threshold value.

4. The method according to claim 3, characterized in that the humidity of the air laterally exiting from the ballast body is detected at a plurality of sites and an average value is obtained from these individual air-humidity values, and that the heating the ballast body is terminated when the average humidity of the air is below a presettable threshold value.

5. The method according to claim 1, characterized in that said mixture is introduced, depending on the height of the ballast body at the point of application, in a quantity that is all the larger the more upwards in the ballast body the application point is situated.

6. A method for making a track bed structure for a railway on a subgrade inclined transversely to the length thereof, wherein
an elastic drain mat (14) is arranged on the subgrade,
a ballast body (16) of individual ballast stones (18) having voids between them is formed, notably on the drains mat (14), if existing,
sleepers (20) are embedded into the ballast body (16),
rails (24) are fastened on the sleepers (20), and
for positional fixation of the ballast stones (18) arranged substantially only within load transfer regions (26) of the ballast body (16) below the sleepers (20), a foamable material (28) is introduced into the voids between the ballast stones.

7. The method for making a track bed structure according to claim 6, characterized in that the ballast stones (18) are washed before the ballast body (16) is built and/or before the foamable material (28) is introduced into the ballast body (16).

8. The method for making a track bed structure according to claim 6, characterized in that the ballast body (16) is heated prior to the introduction of the foamable material (28).

9. The method for making a track bed structure according to claim 6, characterized in that sleepers (20) with a footing (30) of an elastic material are embedded into the ballast body (16).

10. The method for making a track bed structure according to claim 6, characterized in that, prior to the introduction of the foamable material (28), the ballast body (16) is compacted and/or vibrated to cause a first settlement.

11. A method for preparing mineral fractions connected to each other by a foamed polymer material, wherein, in said method,
polymer-fixed mineral fractions are introduced into a furnace,
the polymer-fixed mineral fractions are heated in such a manner that the polymer material is converted into the gaseous phase,
the gas is subjected to an exhaust-gas cleanup process, and
the mineral fractions substantially freed of polymer are removed from the furnace.

12. The method of claim 11, wherein the furnace is a rotary furnace.

13. The method of claim 1, wherein the mineral fractions comprise rock matter including one or more of track-ballast stones and gravel, and wherein the foamed polymer material comprises a PU-based foam.
